(19) United States
(12) Patent Application Publication
(10) Pub. No.: US 2009/0012904 A1
(43) Pub. Date: Jan. 8, 2009

(54) NON-LIQUID ASSET EXCHANGE

(76) Inventor: Jonas McCord, Beverly Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/111,367

(22) Filed: Apr. 29, 2008

Related U.S. Application Data
(60) Provisional application No. 60/927,117, filed on Apr. 30, 2007.

(51) Int. Cl. G06Q 30/00

(52) U.S. Cl. 705/80; 705/26

(57) ABSTRACT

Methods and systems are disclosed for providing an open exchange for non-liquid assets, such as high-end collectibles, valuable works of art, and real estate. Methods are provided for providing listings and handling purchase offers for assets which are not presently for sale. Additional methods are disclosed for using such offers as evidence of the value of the related assets.

### CROSS-REFERENCES TO RELATED APPLICATIONS

This application claims the benefit of U.S. Provisional Patent Application No. 60/927,117, filed Apr. 30, 2007, entitled “Non-Liquid Asset Exchange”, which is hereby incorporated by reference in its entirety.

### BACKGROUND OF THE INVENTION

The present invention relates to computer systems and software for enabling Internet markets, such as auction and property listing services.

A number of methods have emerged in recent years for providing an open market for private individuals to exchange goods and services. Internet auctions such as eBay are the most prevalent variety. Other examples include more focused exchanges, typically allowing individuals to list a used product alongside a merchant's listing for a new product. Amazon.com is the most widely known example of this.

These open exchanges provide exposure for an individual seller of a scale far beyond what was available before the advent of the Internet. However, present systems have their limitations.

First and foremost, existing open exchanges tend to focus on lower end products. There are a number of reasons for this, including concerns about security, low volume, the desire to see high-end goods up-close, the prevalence of more complex transactions in such cases, and others.

Second, existing exchanges are limited to listing of goods which are subject to an active offer of sale. This makes sense for many open exchanges, as listings take up storage and bandwidth space, and most users of open exchanges are not interested in looking at listings of items which are not presently for sale.

An exception arises with certain classes of assets, however. For example, many people would be interested in seeing listings of ownership of well-known works of art, whether the pieces are presently offered for sale or not. The same is true of real estate, high-end collectibles, and other rare, famous, or unique assets. Further, many individuals would like to have the ability to make purchase offers for these sorts of assets, even if the owners are not presently offering them for sale.

A system such as this would provide advantages for owners of the assets as well. For example, offers made via the system could be used as evidence of the value of an asset for tax purposes, for assessing collateral, or other situations where estimating the value of such an asset is necessary.

Some limited progress has been made in this area. For example, the listing of collectibles which are not for sale alongside collectibles which are for sale is known. See Published Patent Application No. 2004/0044593 (“May”). However, the method disclosed in May is designed merely to “stimulate browsing and interaction with other collectors.” May at Abstract. It does not disclose the sort of open exchange for these assets described above.

In fact, no existing exchange offers these capabilities. Accordingly, a need for such a solution exists. Embodiments of the invention address these and other problems.

### BRIEF SUMMARY OF THE INVENTION

Embodiments of the invention are directed to methods and systems for providing an open exchange for non-liquid assets. As used herein, the term “non-liquid assets” means assets which are not presently offered for sale, and for which the market value is not widely known. Examples include without limitation works of art by prominent artists, high-end collectibles, antiquities, and real estate. Many other similar asset categories exist which would be appropriate for use with the invention. In addition to assets not presently for sale, the exchange can list assets that are for sale.

In one embodiment, the exchange solicits bids for potential sale, similar to an auction, but without the potential seller being obligated to sell. Alternately, the solicited bids can be used to simply value an object, for purposes of donation or simply for information purposes.

One embodiment of the invention is directed to a method of operating a computer system. This method comprises receiving from a first user information about an asset in which the first user has an ownership interest, where the ownership interest is not currently offered for sale; publishing a portion of the information about the asset; receiving from a second person an offer to purchase the ownership interest; sending the offer to the first person; and if and when the first person chooses to accept the offer, allowing the second person to purchase the ownership interest from the first person according to the terms of the offer.

The exchange transaction can occur directly between potential sellers and potential buyers, or through a third-party exchange service. The potential sellers and buyers can interact directly with the exchange, or can use a financial institution or agent to perform some or all of the tasks associated with the exchange.

### BRIEF DESCRIPTION OF THE DRAWINGS

FIG. 1 is a flow chart illustrating a method according to an embodiment of the invention.

FIG. 2 is a flow chart illustrating a method according to an embodiment of the invention.

FIG. 3 is a flow chart illustrating a method according to an embodiment of the invention.

FIG. 4 is a block diagram illustrating a system according to an embodiment of the invention.

FIG. 5 is a diagram of the components or subsystems of a computer apparatus used in an embodiment of the invention.

FIG. 6 is a flow chart illustrating another embodiment of the invention where an asset is placed on the exchange to secure a loan against it.

FIG. 7 is a flow chart illustrating another embodiment of the invention where an asset is placed on the exchange to obtain evidence of value for a tax deduction or donation.

### DETAILED DESCRIPTION OF THE INVENTION

Embodiments of the invention are directed to methods and systems for providing an open exchange for non-liquid or semi-liquid assets. These assets will typically be of high-end varieties such as rare collectibles, valuable works of art, and real estate. Other possible assets include fine wines, sports memorabilia and other collectables, aircraft, boats, etc. A common aspect of such assets is that collectors and other interested parties frequently desire information about the assets, even if they are not presently for sale. Further, collectors would often like the opportunity to make an offer to purchase these assets, even if they are not subject to a current offer of sale.

### A Perpetual Auction

In a typical embodiment, a service provider operates an exchange service (“the exchange”) via a Web site. Individuals or other entities may be allowed to join as members. Members may list their assets on the Web site. A listing may include such information as photographs, proof of purchase, proof of authenticity etc. The type of information included will vary with the type of asset listed.

An Asset may be assigned a baseline valuation, which may be displayed in the listing. This baseline valuation may be determined by the purchase price, the amount for which the asset is insured, an appraisal, or other appropriate means. A “perpetual auction” may then take place, wherein other members of the exchange make purchase offers of increasing size. This auction may operate indefinitely and continuously, 24 hours a day, until the owner of an asset chooses to accept an offer, or to remove the listing. An owner typically will be under no obligation to accept any purchase offer made, or to end the listing at any pre-determined time. If an offer is accepted, the exchange may assist with execution of the transaction, and collect a fee. In some embodiments, the fee may be a percentage of the purchase price.

Some embodiments of the invention may allow members to make more complex purchase offers, including additional terms, offers of barter, etc. Such offers may be allowed even though offers of simple monetary amounts are pending. The exchange may choose whether or not to publish the terms of such offers depending on their complexity and the wishes of the members in question. The exchange may choose to charge a different fee structure for these alternative transactions, depending on the terms offered.

In some embodiments, the exchange may require that offers made by prospective buyers be standing and binding. In other words, the member who makes the offer is obligated to execute the purchase according to the offered terms if accepted by the owner. In some embodiments, the exchange may require that the offer remain open and binding indefinitely, until explicitly removed by the prospective buyer. In other embodiments, the exchange may allow offers to expire after a pre-determined time period. Other embodiments may allow non-binding offers to be made.

Typical embodiments will require that offers be made in the form of bids of increasing monetary amounts, as with traditional auctions. The exchange may display only the highest bid, or a series of progressive bids may be shown.

### Futures And Options

Some embodiments may allow the exchange of futures and/or options on the assets listed on the exchange. The futures and options may resemble widely-known instruments used in other exchanges, such as the stock market. For example, a buyer may offer to enter into a future contract on an asset by offering to make immediate payment of a specific amount (the “strike price”), in exchange for receiving ownership of the asset at a later date. This example resembles standard futures contracts traded on familiar stock and commodity exchanges. Similarly, a buyer may offer to purchase an option on an asset by offering a specific amount (or other consideration) for the right to purchase an asset for a pre-determined period of time, and at a pre-determined “strike price.” This example resembles standard “call” options. Finally, the exchange may elect to allow potential buyers to sell options to asset owners whereby an owner would, in exchange for consideration, purchase the right to sell the asset to the potential purchaser for a pre-determined period of time at a pre-determined strike price. This example resembles standard “put” options.

The exchange may allow futures and/or options purchases to be initiated by asset owners, purchasers, or both. The exchange may choose to standardize the time periods for the contracts, or to allow parties to select their own time periods. Some embodiments may also allow third parties to trade options and futures on assets on a “cash-settled” basis, similar to futures contracts on individual stocks and indices. In other words, the buyer of a contract would be entitled to collect the cash value of the contract, if any, from the seller at the time of expiration. The value of the contract would be determined by the strike price of the contract, and the current highest bid for the asset. (See next section).

It should be understood that the above examples of futures and options are merely illustrative, and any standard method of exchanging futures, options, or other familiar asset-based derivatives may be used according to the invention.

### Asset Owner Benefits

Owners of listed assets benefit in several ways. First, an owner who is not aware of the present market value of an asset may be persuaded to sell it if a sufficiently high offer is made. Using an intermediary such as the service provided by embodiments of the invention allows such offers to be made in an anonymous and unobtrusive manner, so that owners who are truly uninterested in selling will not be pestered by solicitations to purchase. Owners may also appreciate the prestige value of making public their ownership of prominent works of art, or other well-known assets.

Further, owners may use purchase offers as evidence of the current market value of an asset. Typically, the highest open bid may be used as an estimate of the current market value. This estimate can be useful in a variety of different ways. For example, evidence of the value of an asset can be useful in determining the proper tax deduction for an asset donated to a non-profit organization. Similarly, a comparison of the highest open bid with the member's cost basis for the asset can be used to estimate the potential tax consequences of selling the asset. Some embodiments of the invention may provide information about the potential tax benefits of donation and/or tax consequences of selling as a service to owners. This information may be provided on a display page of a Web site, or by other appropriate means.

In addition, the estimate of the market value of the asset may be used by an owner to secure a loan using the asset as collateral. Some embodiments may provide information about potential loan amounts which may be available if the asset is put up as security. Information about available loan terms may be provided to an owner on a display page of a Web site, or other appropriate means. The exchange may also assist with negotiation and origination of loans to members by financial institutions affiliated with the exchange. (See “Membership and Affiliation,” infra). The exchange may use any and all information it has obtained about an asset and its owner in negotiating and originating these loans. The exchange may charge a fee to the owner and/or the financial institution for this service.

Further, working artists may wish to market their pieces through the exchange, gaining the benefit of a competitive bidding process, without the time constraints or obligation to sell inherent in a traditional auction.

### Membership And Affiliation

In order to maintain a high level of quality in its listings, and to prevent frivolous purchase offers, the exchange may choose to limit its membership to certain classes of individuals, such as accredited investors, artists with a minimum portfolio value, or according to other appropriate criteria. Similarly, the exchange may require verification of available funds before allowing a purchase offer to be made by a member. The exchange may collect personal information from prospective members in order to verify that a candidate qualifies for membership. Limiting membership in such a way could have the additional benefit of creating an air of exclusivity for the exchange, which would be of value when marketing the exchange to wealthy individuals.

The exchange may choose to charge a membership fee to some classes of members. In some embodiments, a fee will be charged to individuals and for-profit entities, but not to non-profit entities or artists who market their work via the exchange. Other embodiments may choose to charge a membership fee to other classes of members, or not to charge a membership fee at all.

Business entities may also be allowed to become members, including corporations, limited partnerships, and non-profit entities such as museums. These entities could list their own holdings, or make purchase offers in the same manner as individuals. It may also be desirable to allow non-profit entities to join for the purposes of receiving charitable donations of assets such as fine art and antiquities. The exchange may allow non-profit entities to solicit such donations from owners, possibly limiting the practice to owners who have given explicit permission. The exchange may choose to charge a reduced fee, or no fee at all, for such transactions.

The exchange may choose to affiliate with one or more financial institutions. The financial institutions may provide assistance with financing and/or completion of complicated transactions surrounding the assets listed by the exchange. Affiliated financial institutions may also be allowed to initiate loans using listed assets as collateral.

In some embodiments, membership in the exchange may be limited to clients of affiliated financial institutions, which would provide access to the exchange as a service to their customers. In such embodiments, the exchange may choose to collect a fee from the affiliated financial institutions in exchange for being allowed to provide access to the exchange.

### Privacy

The exchange may choose to allow members to remain anonymous. This could be accomplished by issuing numbered accounts. The account numbers could be listed in encrypted form, and/or changed for each listing. In some embodiments the exchange may allow members to choose whether or not to remain anonymous. In other embodiments, the exchange may choose to keep all members anonymous. The decision will vary according to the targeted clientele.

In the case of a transaction where one or both parties is anonymous, the exchange may execute the transaction without revealing the identity of either party to the other. This could be performed directly by the exchange and/or its agents, or indirectly via an affiliated financial institution or other appropriate means. In the case of an anonymous transaction, the exchange may elect not to publish the fact that a transaction has taken place, or that ownership of the asset has changed. Rather, the listing may remain unchanged on the site, so that other members will have no way of knowing if and when a transaction has occurred.

The Exchange may also control the amount of information that is published on the Internet at large. For example, some embodiments may restrict access to all information regarding assets and members to members of the site. Other embodiments may publish portions of the information for viewing by the general public. In these embodiments, a human employee of the exchange may determine what information is revealed to the public about each listing. Further, identification information about the owner of an asset may be kept in a separate database from information about the asset itself.

Any division between the portion of the information that is kept public and the portion that is kept private may be used according to the invention. The particular subset of information published will depend on the types of assets listed, and the needs and wishes of the clients and affiliates of the exchange.

Additional security measures may also be implemented in order to preserve privacy and prevent unauthorized access. For example, some embodiments may employ biometric identification technology to control access to the exchange. These embodiments will typically require physical interaction or proximity between a member and a device in order to grant access to the exchange. Any appropriate form of biometric recognition may be used according to the invention. Preferred embodiments will use portable devices such as mobile phones, PDAs, etc., with integrated biometric recognition components, so that members may securely access the exchange from any location.

### Banking Service

In one embodiment, banks or other financial institutions can offer membership to their clients. A client desiring to make a bid can make the bank an agent, either by a physical signed document or through the bank's website with an electronic authorization. Thus, once the client places a bid, and it is accepted, the bank is already authorized to access the client's account for funds to transfer to effect the sale, and to issue any necessary documentation with the client's account information. Similarly, a seller can list items through a financial institution agent.

In one embodiment, one or more financial institutions are designated as escrow agents to consummate transactions between a buyer and seller. The escrow agent receives the funds and accompanying documents from the buyer, and the executed deed or actual asset from the seller, and then effects the transfer when both are received and in order. The necessary documentation can be automatically generated for standard types of transactions, with information already provided by the seller or buyer directly, or through their financial institution agents.

For charitable contributions, the seller can empower a bank or other agent to donate the asset to a designated charity after sufficient bids are received to value the asset. The bank will be charged with monitoring the bids and completing the transaction and delivery. The bank can also perform the service of soliciting and/or qualifying possible charities to contribute to.

### Survey Service

In one embodiment, members of the exchange will be provided with survey reports of the global market areas serviced. The survey can show market trends in fine arts, antiquities, real estate, etc. The survey can provide information on consummated sales, as well as information on current bids. The bid information may be processed to make it more usable, such as by averaging bids for a piece of property after throwing out the high and low bid. Classes of properties may be grouped together. For real estate, this is rather straight-forward, since location, size, etc. provide objective standards. For paintings, they can be grouped by artist. Other assets can be similarly grouped.

### EXAMPLE OF A PREFERRED EMBODIMENT

The following example is provided by way of illustration, and should by no means be interpreted to limit the scope of the invention in any way.

A service provider operates an exchange on a secure Web site. Access to the Web site is strictly limited to members of the exchange. Members gain authorization to access the site by a biometric recognition application integrated into a cellular phone, which is provided by the exchange. Information about assets is manually selected for publication by employees of the exchange, based on the wishes of the owners. All personal information about each member is maintained in a separate, secured, and encrypted database, which is not accessible from the Web site.

Owners of assets are identified by id number only, and the number changes at regular intervals. No direct communication is allowed between members. Rather, all communications, negotiations, and transactions are conducted with the exchange as intermediary.

The exchange maintains affiliations with one or more financial institutions, which provide access to the exchange to their customers as an exclusive exchange to wealthy clients. Membership in the exchange is limited to 1) individuals, corporations, hedge funds, and other entities with a minimum of $100 million in assets; 2) estates of deceased with assets that qualify for listing via the exchange; 3) working artists whose works sell for a minimum of $1 million each; 4) non-profit organizations such as museums and academic institutions. The exchange charges membership fees, which may be waived on a case-by-case basis for non-profit organizations and/or working artists. The exchange allows listing of any kind of asset, so long as the asset has an estimated value of at least $1 million. The exchange employs professional appraisers to estimate the value of assets prior to listing.

An offer to purchase an asset is binding, and remains open until cancelled. The exchange or an affiliated financial institution verifies a member's ability to pay the offered price before publishing the offer. An asset owner is never obligated to accept a purchase offer (except in the case of executed options and futures contracts).

The exchange allows exchange of options and futures contracts, as described above. In cases where an asset does not actually change hands, the exchange charges a handling fee for issuance of the contracts. The exchange also allows complex offers and offers of barter. The exchange charges a fixed handling fees for these types of offers as well.

### Illustrations

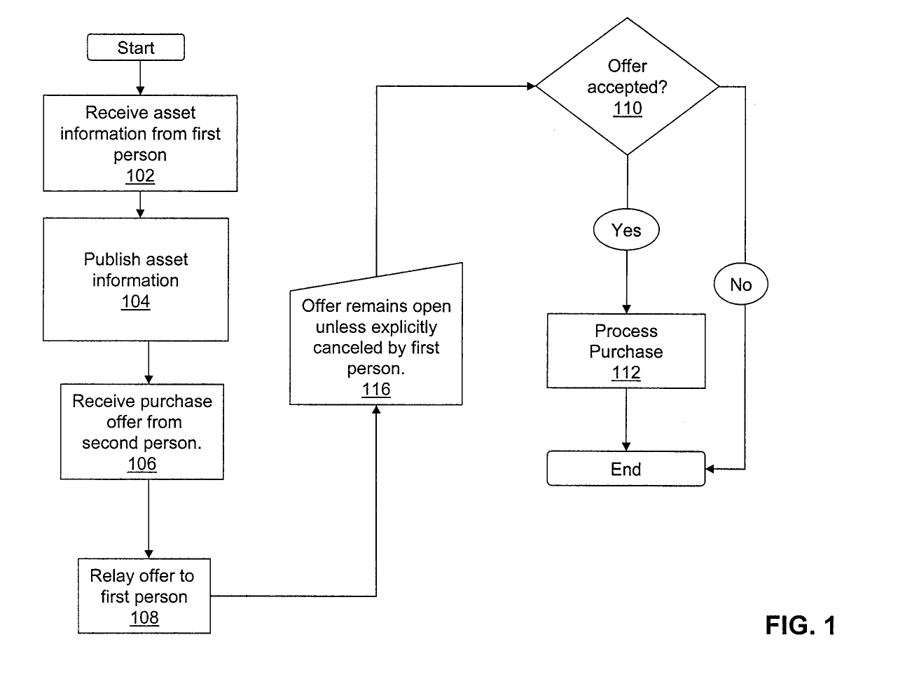

FIG. 1 shows a flow chart illustrating a method according to an embodiment of the invention. In the first step 102, a first person who holds an ownership interest in an asset provides information about the asset to the exchange. Note that it is not necessary for the first person to own the asset outright. Exchange of partial interests are common in certain asset classes, such as real-estate. Accordingly, such partial ownership interests may be listed according to the invention. Further, the ownership interest in the asset may or may not be for sale at the time the information is provided. In fact, due to the nature of the invention, the ownership interest will most often not be for sale.

The exact information provided will vary depending on the type of asset in question. For example, for a rare collectible, information about the condition, date, prior ownership, etc. may be provided. For a rare coin, numismatic grading information may be provided. In preferred embodiments, the information will include photographs, the percentage of the ownership interest, and whatever details are considered to be of interest to collectors or potential buyers of the asset class.

In the next step 104, information about the asset is published. This will typically be accomplished via display on a Web site, although other methods such as print publications are possible according to the invention. The exchange will not necessarily publish all available information about the asset. For example, some asset owners may wish to remain anonymous. Others may wish to keep certain pieces of information about their assets secret, or to divulge them only to those who express serious interest in making a purchase offer. Preferred embodiments will provide these options to asset holders.

In the next step 106, a second person makes an offer to purchase the ownership interest in the asset. The particulars of the offer will again vary according to the asset class. For example, earnest money may be required in some cases such as for real estate. Some embodiments may also allow for complex offers involving more than simple monetary amounts to be made. For example, combinations of money and other assets might be offered, or financing terms may be included. Preferred embodiments will allow such complex offers to be made, even if this limits the level to which transactions may be automated. This makes economic sense because of the low-volume and high-price nature of such transactions.

In the next step 108, the offer is relayed back to the first person, who may choose to accept the offer according to its terms 110, or enter into a negotiation with the second person, with the exchange acting as an intermediary. If the offer is accepted or a deal is made, the exchange then processes the purchase 112. Again, the exact method of accomplishing this will vary according to the asset class. Preferred embodiments will provide all services necessary to facilitate the transaction, such as title management, escrow, etc., either directly or indirectly via referral.

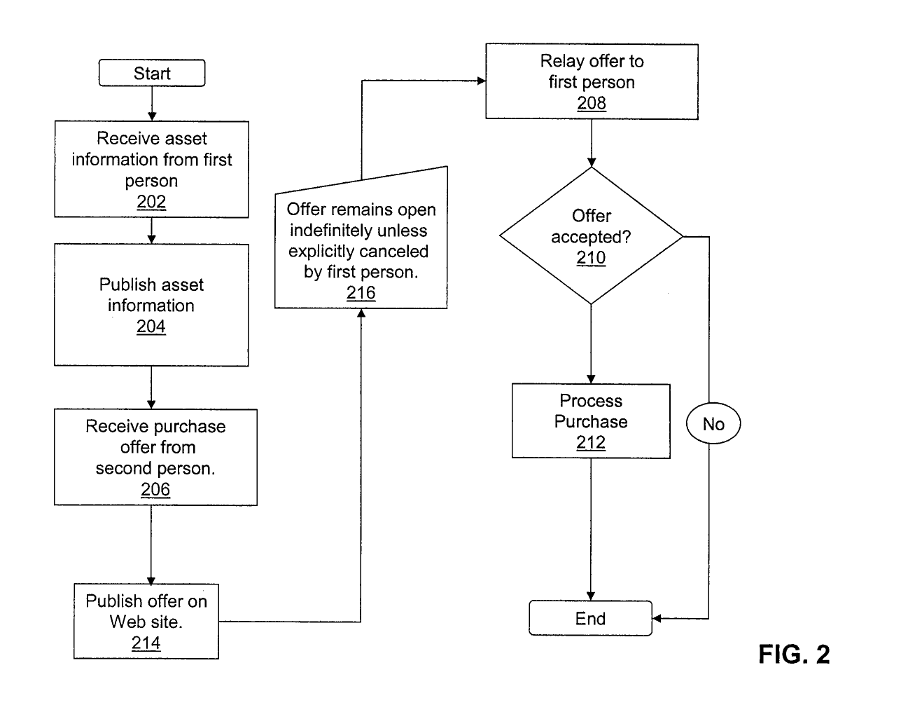

FIG. 2 shows a flow chart illustrating another embodiment of the invention. The first three steps, 202, 204, and 206, are essentially identical to steps 102, 104, and 106 as described above. Their descriptions need not be repeated here. After a purchase offer is received 206, however, this embodiment adds an additional step 214, wherein the exchange publishes the offer. Publication may be accomplished in a variety of ways as described above. Further, the exchange may again choose not to publish certain portions of the offer. For example, the second person may wish to remain anonymous. Some embodiments will allow the second person to choose the portions of the offer terms to be published. In others, the exchange will choose according to its internal policies.

The remaining steps, 208, 210, and 212, are identical to steps 108, 110, and 112, as described above, and need not be described again here.

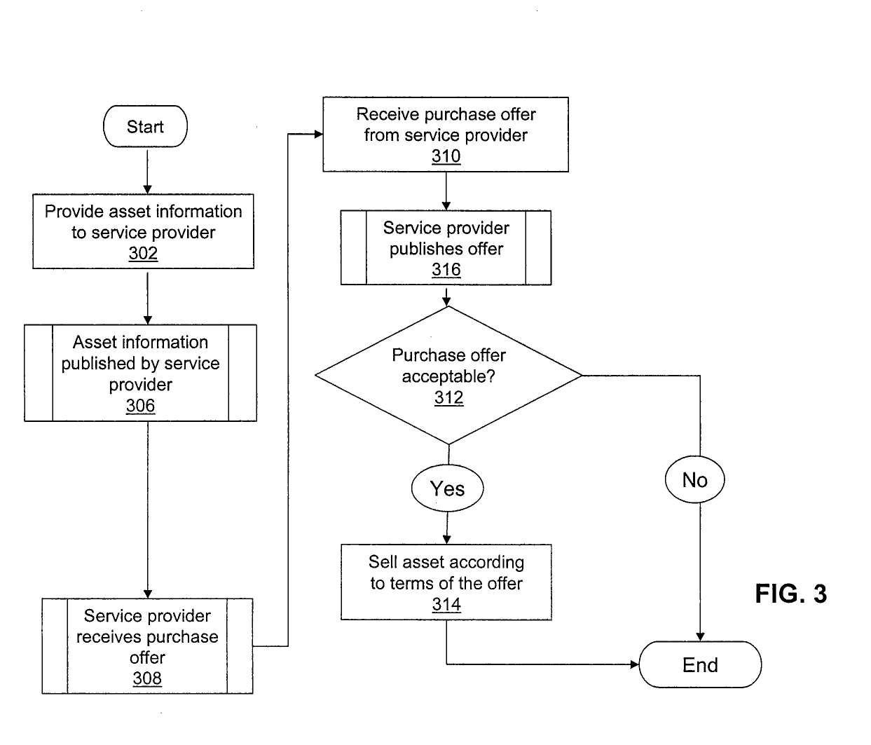

FIG. 3 shows a flow chart illustrating another embodiment of the invention. In the first step 302, the holder of an ownership interest in an asset provides information about the asset to an exchange service provider. The information will vary with asset class as described above for FIG. 1. In steps 306 and 308, the exchange publishes a portion of the information, and receives a purchase offer, as described above for FIG. 1. In step 310, the holder of the ownership interest receives the purchase offer from the exchange. The exchange then publishes the offer 316 as described above for FIG. 2.

The owner determines if the offer is acceptable or not 312. If it is, the owner may sell the ownership interest 314. Alternatively, the owner may use the offer as evidence of the current market value of the ownership interest 318. This evidence can be used to, for example, determine the appropriate tax deduction if the asset is donated to a non-profit organization, or to determine the amount of collateral to grant against the ownership interest if it is used as security for a different transaction.

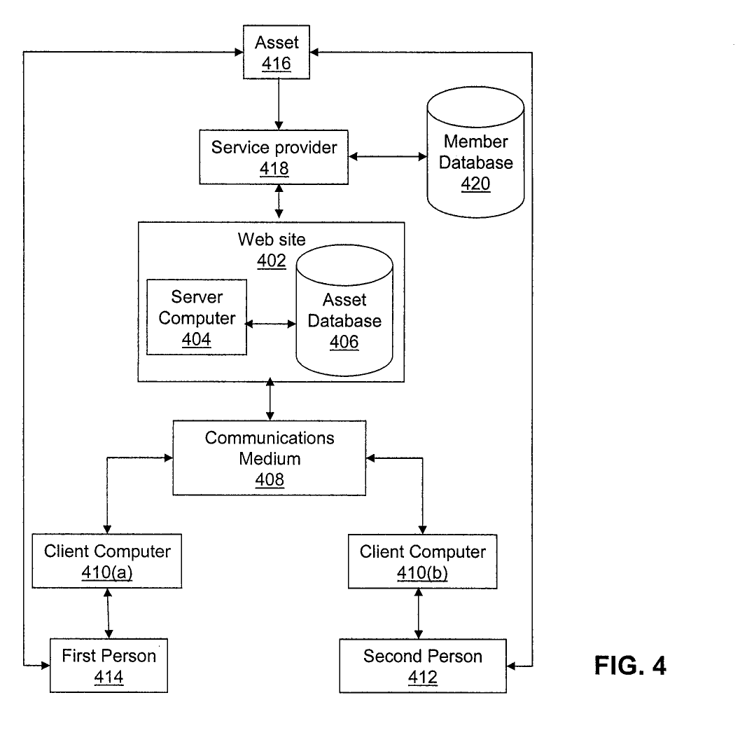

FIG. 4 shows a block diagram illustrating a system adapted to implement some embodiments of the invention. The system includes a first person 414 who holds an ownership interest in an asset 416. The asset may belong to any of a wide variety of asset classes, however preferred embodiments will focus on high-end assets such as rare collectibles, prominent works of art, and real estate.

The system also includes an exchange service provider 418 (“the exchange”), typically a business entity who provides services according to the invention. The exchange 418 will commonly operate a Web site 402 which provides listings of asset information, and interfaces for uploading asset information, and making purchase offers. The system in FIG. 4 illustrates such an embodiment, however, as noted above, other embodiments may use other methods of publication, such as print media.

The Web site 402 will most often include a server computer 404. A server computer is typically a powerful computer or cluster of computers. For example, the server computer can be a large mainframe, a minicomputer cluster, or a group of servers functioning as a unit. In one example, the server computer may be a database server coupled to a Web server.

The server computer 404 may have access to an asset database 406. The database 406 will typically be used to store the listings of asset information, purchase offer information, and other data necessary to implement embodiments of the invention.

The system may include a separate member database 420. In embodiments using a separate member database 420, the exchange will typically maintain a high level of security for membership data, with all of data stored in encrypted form, and access to the member database 420 strictly limited to employees of the exchange. In particular, the Web site 402 typically will not have access to the member database 420.

The system shown includes one or more client computers 410(a), 410(b) in operative communication with the server computer 404 operating the Web site 402, via a communication medium 408. The first client computer 410(a) is used by the first person 414 to access the Web site 108 in order to upload information about the asset 416. The second client computer 410(b) is used by a second person 412 to view asset information, and possibly to make a purchase offer.

The one or more client computers 410(a), 410(b) may include any suitable commercially available computation apparatuses with suitable commercially available Web browsers. Suitable client computers include Macintosh™ and Windows™ based computers.

The communication medium 408 may use any suitable wired or wireless network, including the Internet. Although the communication medium 408 is shown as being separate from the server computer 404 in FIG. 4, the communication medium 408 may alternatively include the server computer 404 in other embodiments.

It is understood that the block diagram in FIG. 4 is simplified for simplicity of illustration. In other embodiments, there may be more or fewer components than are specifically illustrated in FIG. 4.

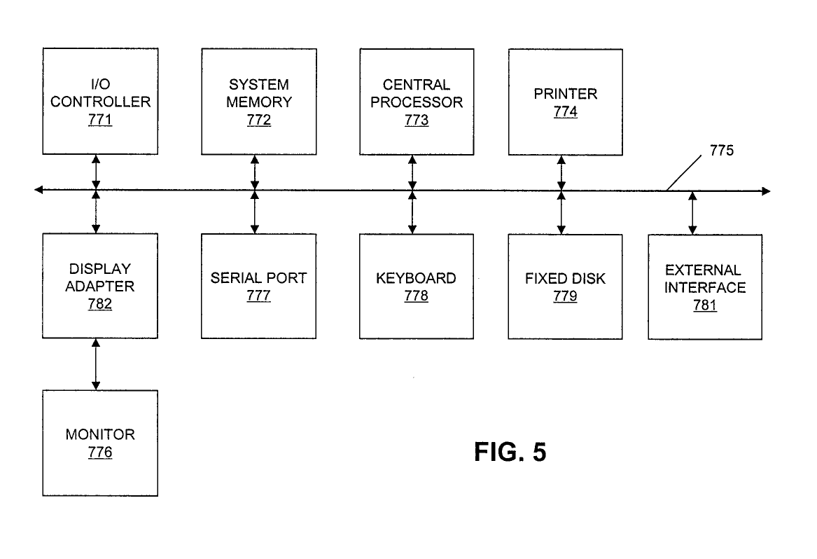

FIG. 5 shows typical components or subsystems of a computer apparatus. Such components or any subset of such components may be present in various components shown in FIG. 4, including the server computer 404, and client computers 410(a), 410(b). The subsystems shown in FIG. 5 are interconnected via a system bus 775. Additional subsystems such as a printer 774, keyboard 778, fixed disk 779, monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus 775 allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

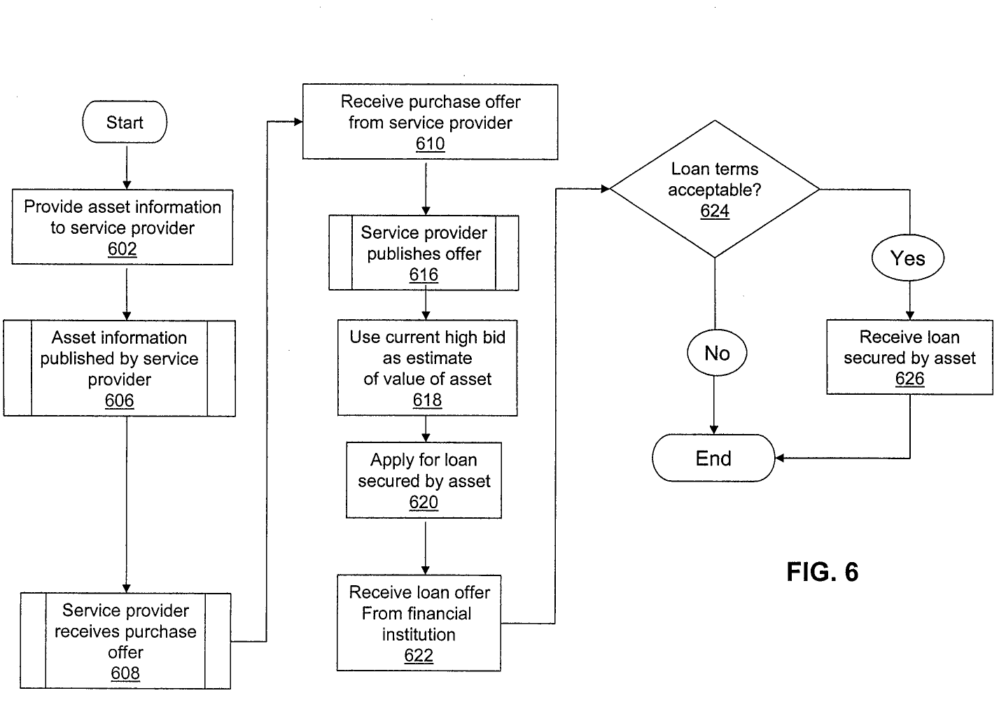

FIG. 6 shows a flow chart illustrating another embodiment of the invention. In this method, an owner of an asset uses bids placed via the exchange as evidence of the value of an asset, in order to secure a loan against it. In the first step 602, the holder of an ownership interest in an asset provides information about the asset to an exchange service provider. The information will vary with asset class as described above for FIG. 1. In steps 606 and 608, the exchange publishes a portion of the information, and receives a purchase offer, as described above for FIG. 1. In step 610, the holder of the ownership interest receives the purchase offer from the exchanger. The exchange then publishes the offer 616 as described above for FIG. 2.

The owner may then use the current high bid as an estimate of the value of the asset 618. As this suggests, multiple increasing offers may be made in the form of bids, and at any point, the highest bid may serve as an estimate of value.

In the next step 620, the owner applies for a loan from a financial institution, the loan being secured by the asset. In preferred embodiments, the financial institution will be affiliated with the exchange, however, any financial institution may be used according to the invention. The then owner receives an offer of loan terms 622 from the financial institution. If the terms are acceptable 624, the owner may then proceed with the loan 626.

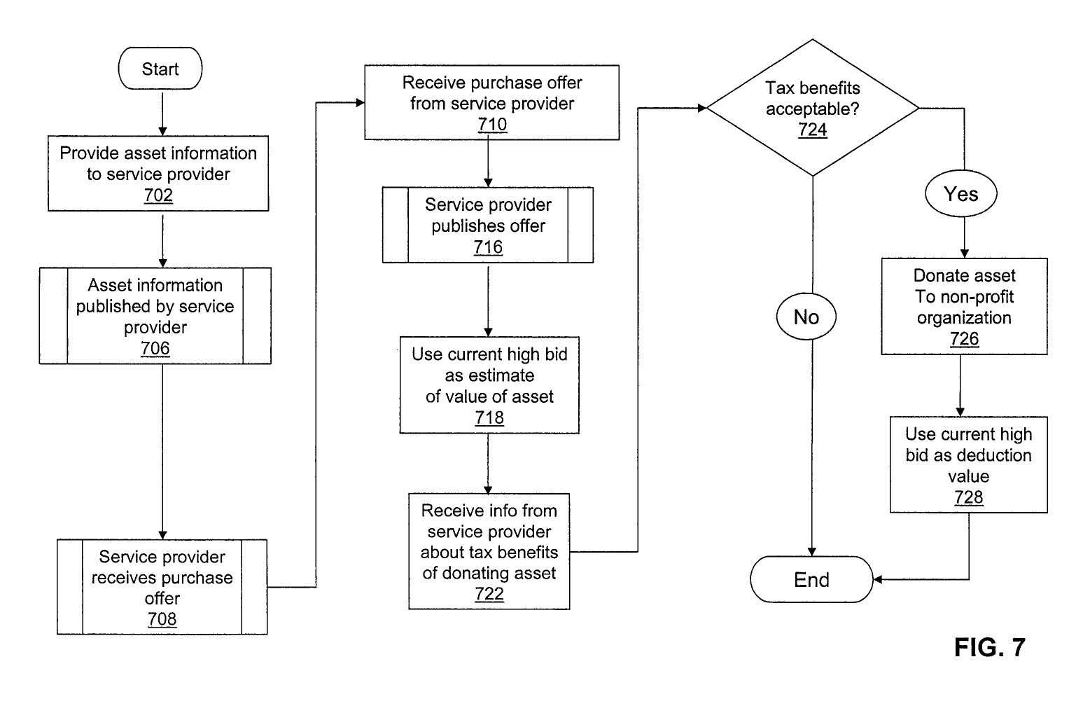

FIG. 7 shows a flow chart illustrating another embodiment of the invention. In this method, an owner of an asset uses bids placed via the exchange as evidence of the value of an asset for the purposes of receiving a tax deduction for donation of the asset to a non-profit organization. In the first step 702, the holder of an ownership interest in an asset provides information about the asset to an exchange service provider. The information will vary with asset class as described above for FIG. 1. In steps 706 and 708, the exchange publishes a portion of the information, and receives a purchase offer, as described above for FIG. 1. In step 710, the holder of the ownership interest receives the purchase offer from the exchange. The exchange then publishes the offer 716 as described above for FIG. 2.

The owner may then use the current high bid as an estimate of the value of the asset 718, as described above for FIG. 6. In the next step 722, the owner receives information from the exchange about the potential tax benefits of donating the asset to a non-profit organization. In preferred embodiments, the non-profit organization will be an affiliated member of the exchange, but any non-profit may be used according to the invention.

If the owner is interested in donating the asset, and finds the tax benefits acceptable 724, the owner may then proceed with donating the asset 726. He or she may then claim the amount of the highest bid made on the asset via the exchange as a tax deduction 728. Alternatively, if the IRS implements new rules regarding use of auction bids for the purposes of determining the value of a deduction, the deduction taken may in accordance with the invention be sized as required by the IRS.

Any of the above-described methods or steps of such methods may be embodied as software code to be executed by a processor of the server computer or any other suitable combination of devices using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM.

It should be understood that the present invention can be implemented in the form of control logic, in a modular or integrated manner, using software, hardware or a combination of both. Based on the disclosure and teachings provided herein, a person of ordinary skill in the art will appreciate other ways and/or methods to implement the present invention.

Embodiments of the invention have a number of advantages over existing technologies. First, the invention allows for non-liquid and semi-liquid assets to be listed in an exchange, even if they are not presently for sale. This provides several benefits. First, an owner of an interest in an asset may not be aware of its true market value, and may in fact be willing to sell if a sufficiently high offer is made. Second, offers may be used as evidence of market value of assets for tax purposes, or for other situations where an estimate of the value of an asset is required. Third, collectors and others interested in the asset classes listed will appreciate having access to information regarding the assets, and the opportunity to make purchase offers, even if the asset is not technically for sale.

Embodiments of the invention also provide an open exchange environment that is geared toward high-end items, and designed to handle the complex transactions that frequently occur in relation to such items.

What is claimed is:

1. A method comprising:
receiving from a first user an electronic communication with information about an asset in which the first user has an ownership interest, where the ownership interest is not currently offered for sale;
publishing a portion of the information about the asset;
receiving from a second person an electronic communication with an offer to purchase the ownership interest;
sending an electronic communication to the first person with the offer; and
if and when the first person chooses to accept the offer, allowing the second person to provide an electronic indication of an agreement to purchase the ownership interest from the first person according to the terms of the offer.

2. A method according to claim 1, further comprising:
after receiving from the second person the offer to purchase the ownership interest, publishing information about the offer.

3. The method according to claim 1 where publishing a portion of the information about the asset does not include publishing the identity of the first person.

4. The method according to claim 2 where publishing information about the offer does not include publishing the identify of the second person.

5. The method according to claim 1 where publishing a portion of the information about the asset comprises publication on a Web site.

6. The method according to claim 2 where publishing information about the offer comprises publication on a Web site.

7. the method according to claim 1, further comprising:
if and when the second person purchases the ownership interest from the first person, receiving a commission on the sale.

8. The method according to claim 1, where the offer is binding, and stands until revoked.

9. The method according to claim 1, where the offer is binding, and stands for a pre-determined period of time, after which it expires.

10. The method of claim 1 wherein at least one of said electronic communications is a posting to a website.

11. A method comprising:
publishing with a service provider information about an ownership interest in an asset, where the ownership interest is not currently offered for sale; and
receiving from the service provider an offer from a first person to purchase the ownership interest.

12. The method according to claim 11, further comprising:
accepting the offer; and
selling the ownership interest to the first person according to the terms of the offer.

13. The method according to claim 12, further comprising:
donating the ownership interest to a non-profit organization; and
using the amount of the offer as evidence of the value of the donation.

14. The method according to claim 12, where the offer is binding, and stands until revoked.

15. The method according to claim 12, where the offer is binding, and stands for a pre-determined period of time, after which it expires.

16. A method comprising:
receiving from a first user an electronic communication with information about a non-liquid asset in which the first user has an ownership interest, where the ownership interest is not currently offered for sale;
publishing a portion of the information about the asset on a website;
receiving from a second person an electronic communication with an offer to purchase the ownership interest;
sending an electronic communication to the first person with the offer;
if and when the first person chooses to accept the offer, allowing the second person to provide an electronic indication of an agreement to purchase the ownership interest from the first person according to the terms of the offer;
wherein publishing a portion of the information about the asset does not include publishing the identity of the first person;
wherein the offer is binding, and stands until revoked or the expiration of a time-out period; and
wherein said non-liquid asset is one of a works of art, a collectible, and antique, and real estate.
